(19) United States
(12) Patent Application Publication
(10) Pub. No.: US 2009/0322146 A1
(43) Pub. Date: Dec. 31, 2009

(54) LOCKABLE HYDRAULIC POWER-ASSISTED STEERING SYSTEM

(75) Inventor: David Raban, Tiberias (IL)

Correspondence Address: Pearl Cohen Zedek Latzer, LLP, 1500 Broadway, 12th Floor, New York, NY, 10036, US

(73) Assignee: LOCK-VISION LTD., TIBERIAS (IL)

(21) Appl. No.: 12/303,442

(22) PCT Filed: Jun. 5, 2007
(86) PCT No.: PCT/NL2007/000141

§ 371 Date: Jun. 22, 2009

(30) Foreign Application Priority Data
Jun. 6, 2006 (NL) 1031956

(51) Int. Cl. B60R 25/00; B60R 25/02

(52) U.S. Cl. 303/89; 180/287

(57) ABSTRACT

A lockable hydraulic power-assisted steering system for steering one or more wheels of a vehicle, the system comprising: a hydraulic pump (1) having an inlet (2) and an outlet (3); a hydraulic reservoir (4) having an inlet (5) and an outlet (6); said pump inlet (2) being connected to the reservoir outlet (6); a hydraulic power steering housing (7a), the steering housing being operable by means of a steering wheel and the steering housing having an inlet port (8) and an outlet port (9); a hydraulic circuit, including: a pressure conduit connecting the pump outlet (3) to the steering housing inlet port (8), a return conduit connecting the steering housing outlet port to the reservoir inlet (5), a user operable lock valve (10) which selectively allows to connect and disconnect the steering housing inlet port (8) from the pump outlet (3) and/or to connect and disconnect the steering housing outlet port (9) from the reservoir inlet (5), characterized in that at the inlet port (8) of the hydraulic power steering housing a check valve (25) is arranged.

The present invention relates to lockable hydraulic power-assisted steering system for steering one or more wheels of a vehicle. The vehicle can for instance be a truck, earth-moving vehicle (e.g. a bulldozer), a 4×4, etc.

It is known from the prior art to provide a hydraulic power-assisted steering system with an additional user operable lock valve in the hydraulic circuit, that allows the user to bring the circuit in a “unauthorized use, e.g. theft, prevention mode”.

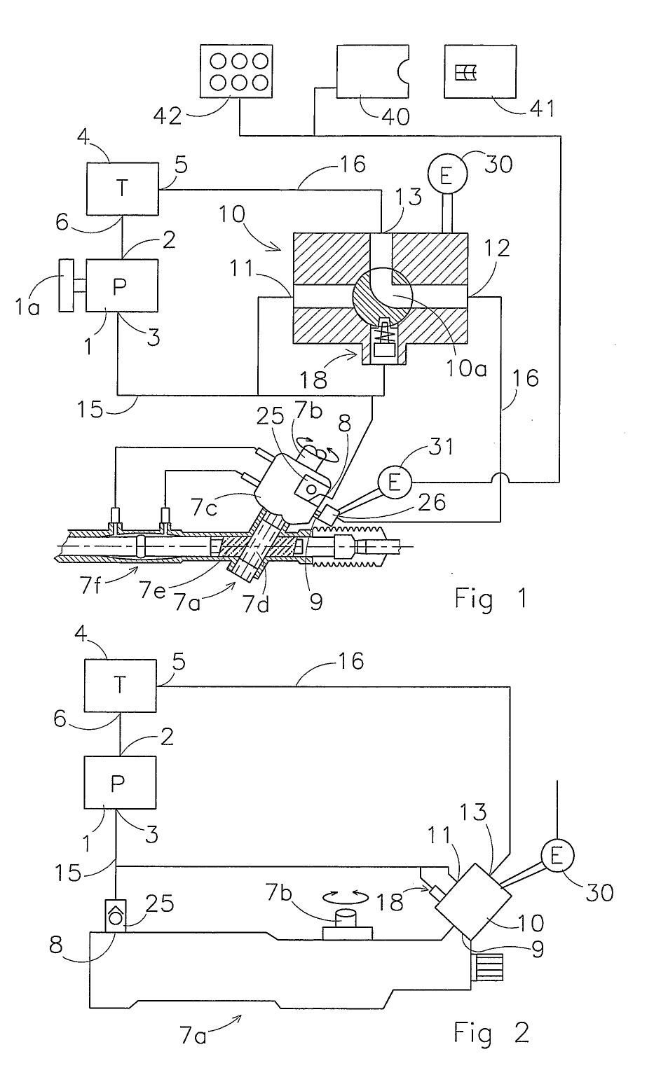

Examples of such steering systems with associated lock valve in the hydraulic circuit between the pump, tank and steering housing are shown in WO 01/58737 (FIGS. 1 and 2) and U.S. Pat. No. 6,598,393 (FIG. 1).

A first aspect of the present invention aims to provide an improved system. This object is achieved by a steering system according to claim 1.

The presence of the check valve at the inlet port of the steering housing effectively enhances the protection against theft.

The inventor has found that in the prior art systems the cutting of the pressure conduit between the lock valve and the inlet port of the steering housing allows the discharge of hydraulic fluid from the steering housing. This gives the thief a possibility to achieve some steering action of the vehicle, even whilst lacking hydraulic power assistance. E.g. for stealing a trailer connected to a truck it is often merely needed to move and steer the truck a small distance in order to disconnect the trailer and steel it by connecting it to another truck.

The first aspect of the present invention effectively locks hydraulic fluid in a section of the steering housing by means of the additional check valve, thereby blocking the steering of the vehicle significantly.

The additional check valve could be arranged outside of the steering housing, directly fitted onto the inlet port of said steering housing. This is envisaged in particular when an existing steering system is retro-fitted with the check valve (and possibly with the user operable lock valve(s) as well). Directly here implies that the check valve housing abuts the steering housing with no conduit being present in between.

In a preferred embodiment the additional check valve is integrated in the steering housing, so that both its presence is quite invisible and access to the check valve is practically impossible for a thief.

In a further preferred embodiment the lock valve has a first inlet and a second inlet as well as an outlet, the outlet being connected to the reservoir inlet, the first inlet being in communication with the pressure conduit, the return conduit from the steering housing outlet port being connected to said second inlet of the lock valve, the lock valve being adapted to—in a first position thereof—close off the first inlet and connect the second inlet to the valve outlet such that the system is operable, and—in a second position thereof—connect the first inlet to the outlet, thereby connecting the pump outlet to the reservoir inlet, and close off the second inlet such that the system is inoperable.

Preferred embodiments of a lock valve as described above are found in WO 01/58737.

In general it is noted that a lock valve could close the relevant passageway completely in its closed position. It is however also envisaged that in its closed position the lock valve leaves open a small bypass, e.g. by suitable design of the mobile valve element and/or the valve housing. The closed position then creates a significant resistance to fluid flow such an effective locking action is obtained. The bypass may serve to prevent an overloading of certain components, e.g. when it is attempted to turn the steering wheel while the lock valve is closed. The bypass may be adapted for each specific system and vehicle.

Preferably the lock valve includes a hydraulic pressure responsive safety element that prevents any operation of the lock valve as long as the pump is in operation as explained in WO 01/58737.

It can be envisaged that a lock valve is arranged at the outlet port of the steering housing, the lock valve being adapted to close the outlet port when theft prevention is desired. In this manner both the inlet port and the outlet port of the steering housing are closed and the steering of the wheels of the vehicle is completely disabled. This outlet port lock valve obviously is preferably also fitted directly at the outlet port of the steering housing, without the presence of an intermediate piece of conduit that could be cut (e.g. by the lock valve housing abutting the steering housing).

It can also be envisaged to integrate the lock valve into the steering housing.

In another practical arrangement a first lock valve is arranged near the pump and/or the reservoir, (which are in practice sometimes combined into a single unit) and the system further includes a second user operable lock valve which is arranged at the steering housing outlet to selectively open and close off said outlet. Again said second lock valve is then mounted directly on the outlet port of the steering housing or integrated into the steering housing.

As is known from the prior art the lock valve or lock valves could be provided with manual operating means, e.g. a physical key operated lock which prevents someone from operating the valve(s) when he does not posses the key.

As explained in WO 01/58737 it is preferred for the operating means of a lock valve to include an electric lock valve drive means and associated user authorization means that prevent unauthorized operation of the lock valve or valves.

The user authorization means could include a keypad for entering a personal code.

A second aspect of the present invention relates to an improved user authorization for a lockable hydraulic system, such as a steering system, wherein the user authorization means for the lock valve includes a card reader, in particular a smartcard reader for reading a code from the memory of a user insertable smartcard.

This system according to the second aspect of the invention is described in claim 12.

It is noted that this system could e.g. lock one or more hydraulic circuits in a vehicle other than the steering systems, such as the tilting of the cab, the brake system, e.g. the hydraulics operation the shovel, etc.

More preferably the user authorization means in addition include the keypad for entering a personal code, so that both the correct card and the correct code have to be provided in order to disable the locking of the hydraulic system. In a practical embodiment the keypad is integrated with the card reader.

The first and second aspect will be illustrated below referring to FIGS. 1 and 2 of the appended drawings.

A third aspect of the invention relates to a truck and trailer combination according to the preamble of claim 13.

As outlined above the provision of a lockable hydraulic power-assisted steering system on the truck greatly enhances the protection against theft. Preferably said system is according to first and/or second aspect of the invention.

In EP 1 382 449 it is disclosed to lock the tilting of the cab of the truck for the purpose of theft prevention in addition to the disabling of the hydraulic steering system using a lock valve. A lock valve having a lock valve portion for each locking function is disclosed therein.

In practice thieves often only steal the loaded trailer by disconnecting it from the truck and connecting the trailer to another truck.

The third aspect of the invention aims to prevent this form of theft, and provides a truck and trailer combination according to claim 13.

In this combination of truck and trailer one or more wheels of the trailer are also equipped with a parking brake cylinder, so that the parking brake immobilizes both the truck and the trailer. Usually a parking brake actuation button or handle is present in the cabin and thus could be actuated by accessing the cabin. Many parking brake systems have a spring in the parking brake cylinder, the spring urging the brake into effect, a fluid pressure or vacuum (depending on the design) counteracting the spring until the parking brake is actuated.

As a lock valve now also is included in the parking brake system, the parking brake can not be disabled by getting entry to the truck cabin and operating the actuation button. To operate the parking brake system the thief now also has to operate the lock valve.

As outlined above such a lock valve is preferably associated with operating means and authorization means for commanding said operating means, e.g. the smartcard and/or personal code solution for commanding the electric drive means of the lock valve.

Therefore the thief will have a further significant obstacle to disable the parking brake and can thus not disconnect the trailer from the truck.

Preferably the lock valve in the truck and trailer combination of claim 13 includes the hydraulic pressure responsive safety element of claim 9 to ensure that no operation of the lock valve can take place during driving.

It is further preferred that the user operable lock valves for the steering system and the parking brake system are integrated in a single lock valve assembly, so that both lock actions are effected simultaneously. In a further embodiment also a lock valve for the cab tilting is provided, possibly integral in an assembly with lock valve portions for the steering and parking brake system.

It will be understood that each of the aspects disclosed here can be applied on itself, yet combinations of the aspects are also envisaged.

In the drawings:

FIG. 1 shows diagrammatically an exemplary embodiment of a lockable hydraulic power-assisted steering system for one or more steerable wheels of a vehicle;

FIG. 2 an alternative version of the lockable hydraulic power-assisted steering system.

In FIG. 1 the relevant elements of a lockable hydraulic power-assisted steering system for steering one or more wheels of a vehicle are shown.

The skilled person will recognize the hydraulic power steering housing 7a, the steering housing being operable by means of a steering wheel (not shown) and the steering housing having an inlet port 8 and an outlet port 9.

Here, as is often the case, the steering mechanism is of the rack-and-pinion type. The steering wheel is attached to a steering shaft 7b which operates a steering valve 7c within the housing, commonly a rotary spool valve. The shaft 7b is provided with a pinion engaging a reciprocable rack member 7e in the housing 7a.

The rack member 7e is associated with a hydraulic power assist cylinder mechanism 7f, having two variable volume chambers on opposite sides a piston mounted on the rack member. The steering valve 7c controls the supply and discharge of hydraulic fluid to each of the chambers thereby causing the steering to be assisted by hydraulic power.

Here two conduits are shown between the steering valve 7c and the hydraulic cylinder 7f. It is known for damper valves to be mounted in these conduits. These conduits are commonly mounted against the outside of the steering housing, therefore difficult to access or even integrated in the steering housing.

It will be apparent to the skilled person that the steering housing can have a different design within the scope of the present invention.

The system further includes a hydraulic pump 1 having an inlet 2 and an outlet 3. Here, as is common, the pump 1 has a pulley 1a for a drive belt driven by the vehicle engine or other transmission to said vehicle engine.

The system further includes a hydraulic reservoir 4 having an inlet 5 and an outlet 6. The pump inlet 2 is connected to the reservoir outlet 6. Often the reservoir 4 and the pump 1 form a unit.

The pump outlet 3 is connected via a pressure conduit 15 to the steering housing inlet port 8.

A return conduit 16 connects the steering housing outlet port 9 to the reservoir inlet 5.

Here a user operable lock valve 10 is mounted in the hydraulic circuit between the pump, tank and steering housing.

This lock valve 10 has a first inlet 11 and a second inlet 12 as well as an outlet 13, the outlet 13 being connected to the reservoir inlet 5, the first inlet 11 being in communication with the pressure conduit 15, the return conduit 16 from the steering housing outlet port 9 being connected to the second inlet 12 of the lock valve 10.

As can be readily understood the lock valve 10 has a movable valve element 10a, here a rotary valve element 10a, which is adapted to—in a first position thereof (shown in FIG. 1)—close off the first inlet 11 and connect the second inlet 12 to the valve outlet 13 such that the steering system is operable, and—in a second position thereof—connect the first inlet 11 to the outlet 13, thereby connecting the pump outlet 3 to the reservoir inlet 5, and close off the second inlet 12 such that there is no hydraulic power assistance for the steering and the steering system is inoperable for normal use.

The valve element 10a is here operated by an electric drive 30, e.g. as explained in WO 01/58737.

The FIG. 1 also shows that at the inlet port 8 of the hydraulic power steering housing 7a a check valve 25 is arranged. As is preferred said check valve 25 is integrated within the hydraulic power steering housing (7a).

As mentioned above the provision of the check valve 25 enhance the protection against theft of the vehicle. Cutting the pressure conduit 15, which is often quite accessible, between the pump 1 and the steering housing 7a, has no effect as the check valve 25 locks the fluid in the steering housing.

A second lock valve 26 is shown here at the outlet port 9 of the steering housing. This valve 26 also is user operable, here by means of the associated electric drive means 31. As indicated above said lock valve 26 is preferably directly mounted against the steering housing 7a or integrated therein. With the provision of said valve 26 cutting of the lines leading to the steering housing 7a has no effect for a thief.

As noted in an alternative the lock valve 10 is mounted on the steering housing directly at both the inlet port 8 and the outlet port 9.

As is indicated in the FIG. 1 the lock valve 10 includes a hydraulic pressure responsive safety element 18 that prevents any operation of the lock valve 10 as long as the pump 1 is in operation. This is explained in detail in WO 01/58737.

For providing operating commands for each of the lock valves 10, 26 the system further includes user authorization means. As is preferred these means here include a smartcard reader 40 for reading a user insertable smartcard 41 with a memory. In addition a keypad 42 is provided for entering a personal code.

FIG. 2 shows schematically an alternative version, mainly for large trucks or other larger vehicles. Here the steering housing 7a includes an internal valve controlled by the steering shaft 7b and a hydraulic cylinder controlled by said steering valve. There is no rack-and-pinion mechanism or the like, so no mechanical connection between the steering shaft 7b and the hydraulic cylinder piston rod.

The lock valve 10 is now mounted directly against the steering housing 7a at the outlet port 9. The check valve 25 is here mounted directly against the housing 7a at the inlet port 8.

It is noted that the lock valve at the outlet port 8 could be of a simpler design, simply having an open-close operation for the outlet port 8 and no connection to the pressure conduit 15. However, as explained, the presence of element 18 is preferred to avoid any operation of the lock valve during driving with the vehicle.

1. A lockable hydraulic power-assisted steering system for steering one or more wheels of a vehicle, the system comprising:
a hydraulic pump having an inlet and an outlet;
a hydraulic reservoir having an inlet and an outlet, said pump inlet being connected to the reservoir outlet;
a hydraulic power steering housing, the steering housing being operable by means of a steering wheel and the steering housing having an inlet port and an outlet port; and
a hydraulic circuit, including:
a pressure conduit connecting the pump outlet to the steering housing inlet port,
a return conduit connecting the steering housing outlet port to the reservoir inlet, and
a first user operable lock valve which selectively allows to connect and disconnect the steering housing inlet port from the pump outlet or to connect and disconnect the steering housing outlet port from the reservoir inlet, wherein at the inlet port of the hydraulic power steering housing a check valve is arranged.

2. A system according to claim 1, wherein said check valve is fitted directly on said inlet port.

3. A system according to claim 1, wherein said check valve is arranged within said hydraulic power steering housing.

4. A system according to claim 1, wherein the lock valve has a first inlet and a second inlet as well as an outlet, the outlet being connected to the reservoir inlet, the first inlet being in communication with the pressure conduit, the return conduit from the steering housing outlet port being connected to said second inlet of the lock valve, the lock valve being adapted to in a first position thereof close off the first inlet and connect the second inlet to the valve outlet such that the system is operable, and in a second position thereof connect the first inlet to the outlet, thereby connecting the pump outlet to the reservoir inlet, and close off the second inlet such that the system is inoperable.

5. A system according to claim 4, wherein the first lock valve is arranged near the pump or reservoir, and wherein the system includes a second user operable lock valve which is arranged at the steering housing outlet to selectively open and close off said outlet.

6. A system according to claim 5, wherein the second lock valve is arranged directly at said outlet.

7. A system according to claim 5, wherein the second lock valve is arranged within the steering housing.

8. A system according to claim 1, wherein the lock valve is provided with operating means, and associated user authorization means that prevent unauthorized operation of the lock valve or valves.

9. A system according to claim 1, wherein the lock valve includes a hydraulic pressure responsive safety element that prevents any operation of the lock valve as long as the pump is in operation.

10. A system according to claim 8, wherein the operating means are manual operating means, the user authorization means including a physical key operated lock.

11. A system according to claim 8, wherein the operating means are electric operating means, the user authorization means including an electronic lock, including personal code input means, or a card reader.

12. A lockable hydraulic system, the system comprising:
a hydraulic pump having an inlet and an outlet;
a hydraulic reservoir having an inlet and an outlet, said pump inlet being connected to the reservoir outlet;
a hydraulic actuator having an inlet port and an outlet port; and
a hydraulic circuit, including:
a pressure conduit connecting the pump outlet to the actuator inlet port,
a return conduit connecting the actuator outlet port to the reservoir inlet, and
a user operable lock valve which selectively allows to connect and disconnect the steering housing inlet port from the pump outlet or to connect and disconnect the steering housing outlet port from the reservoir inlet, which lock valve is provided with electric lock valve drive means, and associated user authorization means that prevent unauthorized operation of the lock valve, wherein the user authorization means include a card reader.

13. A truck and trailer combination, said truck having a lockable hydraulic power-assisted steering system for steering one or more wheels of the truck, the steering system comprising:
a hydraulic pump having an inlet and an outlet;
a hydraulic reservoir having an inlet and an outlet; said pump inlet being connected to the reservoir outlet;
a hydraulic power steering housing, the steering housing being operable by means of a steering wheel and the steering housing having an inlet port and an outlet port; and
a hydraulic circuit, including:
a pressure conduit connecting the pump outlet to the steering housing inlet port,
a return conduit connecting the steering housing outlet port to the reservoir inlet, and
a user operable lock valve which selectively allows to connect and disconnect the steering housing inlet port from the pump outlet or to connect and disconnect the steering housing outlet port from the reservoir inlet, which lock valve is provided with lock valve drive means, and associated user authorization means that prevent unauthorized operation of the lock valve, the truck and trailer combination further including a parking brake system with one or more parking brake cylinders associated with at least one wheel of the truck and at least one wheel of the trailer, the parking brake system including one or more conduits connected to each parking cylinder, so as to feed said cylinder with a pressurized fluid or to effect a vacuum so as to disable the parking brake, wherein the combination includes a further user operable lock valve connected to a parking brake conduit, which further lock valve is provided with lock valve drive means, and associated user authorization means that prevent unauthorized operation of the lock valve so that upon locking said further lock valve the associated wheels are immobilized.

14. The combination of claim 13, wherein said user operable lock valve for the steering system and the parking brake system are integrated in a single lock valve assembly, so that both lock actions are effected simultaneously by a common lock valve assembly drive means.

15. The system of claim 12, wherein the user authorization means include a personal code input means.
